(19) United States
(12) Patent Application Publication
(10) Pub. No.: US 2018/0183028 A1
(43) Pub. Date: Jun. 28, 2018

(54) SEPARATOR ROLL AND NON-AQUEOUS SECONDARY BATTERY

(71) Applicant: TEIJIN LIMITED, Osaka-shi, Osaka (JP)

(72) Inventors: Atsuhiro OTSUKA, Osaka-shi (JP); Noboru TANIKAWA, Osaka-shi (JP)

(73) Assignee: TEIJIN LIMITED, Osaka-shi, Osaka (JP)

(21) Appl. No.: 15/324,415

(22) PCT Filed: Jun. 24, 2015
(86) PCT No.: PCT/JP2015/068234

§ 371 Date: Jan. 6, 2017

(30) Foreign Application Priority Data
Jul. 11, 2014 (JP) 2014-143662

(51) Int. Cl. H01M 2/16; H01M 2/14; H01M 10/0525; H01M 10/0587

(52) U.S. Cl. CPC H01M 2/1686; H01M 2/145; H01M 2/1653; H01M 2/166; H01M 2220/20; H01M 2/1666; H01M 10/0525; H01M 10/0587; H01M 2/162

(57) ABSTRACT

A separator roll including a separator wound around a core, the separator including: a porous substrate; and a porous layer obtained by solidifying a coating layer formed by coating one or both sides of the porous substrate with a coating liquid including a resin and/or an inorganic particle, the separator having a shrinkage rate in MD direction, determined by a method, of ≤1.0%, the method including: removing, from the separator roll, the separator by five revolutions of the separator roll starting from an outer end of the separator roll, and cutting out, from an end of the remaining separator roll, a piece of the separator of 200 mm-length in MD direction, to prepare a sample; leaving the sample in a tensionless state at 25° C. for 24 hours; measuring a length of the sample in MD direction before and after the leaving; and calculating the shrinkage rate in MD direction.

### TECHNICAL FIELD

The present invention relates to a separator roll and a non-aqueous secondary battery.

### BACKGOUND ART

With respect to non-aqueous electrolyte battery separators, techniques of imparting functions such as heat resistance and adherence to electrodes by providing a functional layer onto a surface of a porous substrate such as a polyolefin microporous film (for example, Patent Literatures 1 and 2) have been known. As methods for preparing the functional layer, coating methods are known such as a method in which a coating layer is formed by coating a porous substrate with a coating liquid, and dried to remove a solvent in the coating layer, thereby preparing a functional layer, and a method in which a coating layer is formed by coating a porous substrate with a coating liquid, immersed in a coagulation liquid to solidify a resin in the coating layer, and rinsed with water and dried to prepare a functional layer (for example, Patent Literatures 1 and 2). Generally, a separator is produced in a form of a roll with the separator wound around a core (for example, Patent Literatures 3 and 4).

In production of a flat battery such as a rectangular battery or a polymer battery, a separator is wound together with an electrode by a winding apparatus to prepare a battery element, and winding displacement of the battery element may occur, or the battery element may be deformed (e.g. swollen), resulting in poor appearance of the battery. There were many factors including a specification of a winding apparatus, a type of an electrode and so on are involved in winding displacement and deformation of a battery element, and involvement of a separator has not been sufficiently examined heretofore.

### LIST OF PRIOR ART LITERATURE

### Patent Literature

Patent Literature 1: Japanese Patent Application Laid-Open (JP-A) No. 2003-171495

Patent Literature 2: Japanese Patent No. 5431581

Patent Literature 3: Japanese Patent Application Laid-Open (JP-A) No. 2013-216868

Patent Literature 4: Japanese Patent Application Laid-Open (JP-A) No. 2014-12391

### SUMMARY OF INVENTION

### Technical Problem

Embodiments of the invention have been made on view of the situations described above.

An object of an embodiment of the invention is to provide: a separator roll for supplying a non-aqueous electrolyte battery separator which is less likely to cause winding displacement and deformation of a battery element; and a non-aqueous secondary battery with a high production yield.

### Solution to Problem

Specific means for solving the problem include the following embodiments:
<1> A separator roll comprising:

a non-aqueous electrolyte battery separator wound around a core, the non-aqueous electrolyte battery separator comprising:
a porous substrate; and
a porous layer obtained by solidifying a coating layer formed by coating one side or both sides of the porous substrate with a coating liquid, the coating liquid comprising at least one of a resin or an inorganic particle,

the non-aqueous electrolyte battery separator having a shrinkage rate in a machine direction, determined by a method (1), of 1.0% or less, the method (1) comprising:
removing, from the separator roll, the non-aqueous electrolyte battery separator by five revolutions of the separator roll starting from an outer end of the separator roll, and cutting out, from an end of the separator roll that remains after the removing, a piece of the non-aqueous electrolyte battery separator having a length of 200 mm in the machine direction, to prepare a sample;
leaving the sample in a tensionless state at 25° C. for 24 hours; measuring a length of the sample in the machine direction before and after the leaving; and
calculating the shrinkage rate in the machine direction in accordance with the following equation:

shrinkage rate (%) in machine direction=(length in machine direction before leaving−length in machine direction after leaving)÷length in machine direction before leaving×100.
<2> The separator roll according to <1>, wherein the porous substrate comprises a thermoplastic resin having a melting temperature lower than 200° C.
<3> The separator roll according to <1> or <2>, wherein:

the separator roll is a primary roll obtained by winding the non-aqueous electrolyte battery separator directly around a core after production of the non-aqueous electrolyte battery separator, or a secondary roll obtained by winding, around a core, the non-aqueous electrolyte battery separator unwound from the primary roll, and

the primary roll is a separator roll obtained by winding the non-aqueous electrolyte battery separator around a core at a winding speed that is from 100% to 103% of a feeding speed of the porous substrate.
<4> The separator roll according to any one of <1> to <3>, wherein:

the separator roll is a primary roll obtained by winding the non-aqueous electrolyte battery separator directly around a core after production of the non-aqueous electrolyte battery separator, or a secondary roll obtained by winding, around a core, the non-aqueous electrolyte battery separator unwound from the primary roll, and

the primary roll is a separator roll subjected to a treatment including leaving the primary roll to stand in an atmosphere from 40° C. to 110° C. for 12 hours or more.
<5> The separator roll according to any one of <1> to <4>, wherein the non-aqueous electrolyte battery separator has an enlargement rate in a transverse direction, determined by a method (2), of from 0% to 0.6%, the method (2) comprising:

removing, from the separator roll, the non-aqueous electrolyte battery separator by five revolutions of the separator roll starting from an outer end of the separator roll, and cutting, from an end of the separator roll that remains after the removing, a piece of the non-aqueous electrolyte battery separator having a length of 200 mm in the machine direction, to prepare a sample;

leaving the sample in a tensionless state at 25° C. for 24 hours;

measuring a length of the sample in the transverse direction before and after the leaving; and

calculating the enlargement rate in the transverse direction in accordance with the following equation:

enlargement rate (%) in transverse direction=(length in transverse direction after leaving−length in transverse direction before leaving)÷length in transverse direction before leaving×100.
<6> The separator roll according to any one of <1> to <5>, wherein the non-aqueous electrolyte battery separator has a thermal shrinkage rate in the machine direction, determined by a method (3), of from 3% to 40%, the method (3) comprising:

cutting out the non-aqueous electrolyte battery separator from the separator roll to obtain a sample having a length of 190 mm in the machine direction;

subjecting the sample to a heat treatment by leaving the sample in a tensionless state at 135° C. for 30 minutes;

measuring a length in the machine direction before and after the heat treatment; and

calculating the thermal shrinkage rate in the machine direction in accordance with the following equation:

thermal shrinkage rate (%) in machine direction=(length in machine direction before heat treatment−length in machine direction after heat treatment)÷length in machine direction before heat treatment×100.
<7> The separator roll according to any one of <1> to <6>, wherein the shrinkage rate of the non-aqueous electrolyte battery separator in the machine direction, determined by the method (1), is 0.5% or less. p0 <8> The separator roll according to any one of <1> to <7>, wherein the coating liquid comprises an adhesive resin.
<9> A non-aqueous secondary battery comprising:

a positive electrode;

a negative electrode; and

a non-aqueous electrolyte battery separator that is supplied from the separator roll according to any one of <1> to <8>, and that is disposed between the positive electrode and the negative electrode,

the non-aqueous secondary battery producing an electromotive force by lithium doping/de-doping.

### Effect of Invention

According to the invention, a separator roll for supplying a non-aqueous electrolyte battery separator which is less likely to cause winding displacement and deformation of a battery element and a non-aqueous secondary battery with a high production yield are provided.

### BRIEF DESCRIPTION OF THE DRAWING

FIG. 1 is a schematic view for explaining a method of measurement conducted in Examples.

### DESCRIPTION OF EMBODIMENTS

Hereinafter, an embodiment of the invention will be described. The descriptions and examples are intended to illustrate the invention, and are not intended to limit the scope of the invention.

The value range shown using the expression “from . . . to . . . ” in this specification is a range including values described before and after the term “to” as a minimum value and a maximum value, respectively.

In this specification, the “longitudinal direction” means a long direction of a long separator, and the “transverse direction” means a direction orthogonal to the longitudinal direction of the separator. The “longitudinal direction” is also referred to as a “MD direction”, and the “transverse direction” is also referred to as a “TD direction”.

In this specification, the term “step” refers not only to an independent step, but also to a step that cannot be clearly distinguished from other steps as long as an expected action of the step is achieved.

<Separator Roll>

A separator roll of the present disclosure is a separator roll in which a non-aqueous electrolyte battery separator (hereinafter, also referred to simply as a “separator”) produced continuously in a machine direction is wound around a core. The separator in the separator roll of the present disclosure is a separator including a porous substrate and a porous layer provided one side or both sides of the porous substrate, and the porous layer is a porous layer obtained by solidifying a coating layer formed by applying a coating liquid containing a resin and/or an inorganic particle.

In the separator roll of the present disclosure, a shrinkage rate of the separator in a MD direction, which is determined by the following method (1), is 1.0% or less.

Method (1): a separator is removed from the separator roll by 5 revolutions of the separator roll starting from an outer end of a separator roll, and a piece of the separator is then cut out to have a length of 200 mm in a machine direction from an end of the separator roll that remains after the removing to prepare a sample. The sample is left to stand in a tensionless state at 25° C. for 24 hours. A length of the sample in the MD direction before and after the leaving is measured. A shrinkage rate in the MD direction is then calculated from the following equation.

Shrinkage rate (%) in MD direction=(length in MD direction before leaving−length in MD direction after leaving)÷length in MD direction before leaving×100

In the present disclosure, the shrinkage rate of the separator in the MD direction, which is measured by the method (1), is referred to as a “MD-direction shrinkage rate at 25° C”.

The separator supplied from the separator roll of the present disclosure is less likely to cause winding displacement of a battery element in production of the battery element. Further, the separator supplied from the separator roll of the present disclosure is less likely to cause deformation of a battery element.

As a result of investigation, the inventors have found that shrinkage, in the MD direction at room temperature, of a separator having a porous layer provided on a porous substrate by a coating method is related to occurrence of winding displacement and deformation of a battery element. In a case in which a porous layer is provided on a porous substrate by a coating method, it is necessary to apply a tension to the porous substrate for uniformly coating a surface of the porous substrate with a coating liquid. For conveying the porous substrate without causing creases to occur, it is necessary to apply a somewhat strong tension to the porous substrate. As a result of applying a strong tension to the porous substrate at the time of coating the porous substrate with a coating liquid, the porous substrate is extended in the MD direction, so that a separator prepared has the property of shrinking in the MD direction even when the separator is not exposed to a high temperature.

In the separator roll of the present disclosure, the MD-direction shrinkage rate of the separator at 25° C. is 1.0% or less, and therefore in a case in which a battery element is prepared using a separator supplied from the separator roll of the present disclosure, occurrence of winding displacement and deformation of the battery element is suppressed. In the separator roll of the present disclosure, the MD-direction shrinkage rate of the separator at 25° C. is more preferably 0.5% or less from the above-mentioned points of view. The shrinkage rate of the separator in the MD direction at 25° C. is preferably as low as possible. On the other hand, since a battery element can be favorably produced when the separator is somewhat flexible, a lower limit of the MD-direction shrinkage rate at 25° C. is preferably 0.1% or more, and more preferably 0.15% or more.

A technique in which a porous substrate is fixed and heated to remove residual stress on the porous substrate, and a technique in which a content of an inorganic filler in a porous layer is increased to suppress shrinkage of a separator at a high temperature (e.g. around 150° C.) have been heretofore known, but either of these techniques is not a technique of suppressing shrinkage of the separator which occurs at room temperature. A technique of suppressing shrinkage of a separator which occurs at room temperature has not been known so far. As a result of investigation, the inventors have found that the MD-direction shrinkage rate of the separator at 25° C. can be controlled by a contrivance in a process for production of the separator. Details will be described below.

A separator having a porous layer provided on a porous substrate by a coating method further has a property of extending in a TD direction while shrinking in a MD direction at room temperature. Extension of the separator in the TD direction is preferable from the viewpoint of suppressing a short-circuit of the battery. Since extension of the separator in the TD direction has a trade-off relationship with the shrinkage of the separator in the MD direction, it is preferable that the separator does not excessively extends in the TD direction at room temperature. Thus, in the separator roll of the present disclosure, an enlargement rate of the separator in the TD direction, which is determined by the following method (2), is preferably from 0% to 0.6%, and more preferably more than 0% but equal to or less than 0.6%.

Method (2): a separator is removed from the separator roll by 5 revolutions of the separator roll starting from an outer end of a separator roll, and a piece of the separator is then cut out to have a length of 200 mm in the machine direction from an end of the separator roll that remains after the removing to prepare a sample. The sample is left to stand in a tensionless state at 25° C. for 24 hours. A length of the sample in the TD direction before and after the leaving is measured. An enlargement rate in the TD direction is then calculated from the following equation.

enlargement rate (%) in TD direction=(length in TD direction after leaving−length in TD direction before leaving)÷length in TD direction before leaving×100

In the present disclosure, the enlargement rate of the separator in the TD direction, which is measured by the method (2), is referred to as a “TD-direction enlargement rate at 25° C”.

In the present disclosure, specifically the MD-direction shrinkage rate (%) at 25° C. is determined by the following method. The TD-direction enlargement rate (%) at 25° C. can be determined in parallel, and explanation thereof will also be described.

A separator is removed from the separator roll by 5 revolutions of the separator roll starting from the outer end of a separator roll, a piece of the separator is then cut out to have a length of 200 mm in the MD direction from an end of the separator that remains after the removing, and the cut-out separator with a length of 200 mm is used as a sample. One end of the sample is held by a crip, the sample is suspended in a thermostatic bath at a temperature of 25° C. and a relative humidity of 50 ±10% in such a manner that the MD direction coincides with the gravity direction, and the sample is left in a tensionless state for 24 hours. The length of the sample is measured in the MD direction and the TD direction before and after the leaving for 24 hours, and the shrinkage rate (%) in the MD direction and the enlargement rate (%) in the TD direction are calculated from the above two equations. In measurement, a time from starting of the drawing-out of the separator from the outer end of the separator roll to suspending of the sample in the thermostatic bath (i.e. until starting the leaving for 24 hours) is set to be 10 minutes or less, and the length after the leaving for 24 hours is measured immediately after the sample is taken out from the thermostatic bath. Attention should be paid so as not to apply a tension to the separator in preparation of a sample from the separator roll. Details of the measurement method are as described in Examples.

Preferably, the separator wound as the separator roll of the present disclosure has a thermal shrinkage rate of from 3% to 40% in the MD direction as determined by the following method (3).

Method (3): a separator is cut out from a separator roll to obtain a sample having a length of 190 mm in the MD direction. One end of the sample is held by a crip, the sample is suspended in an oven with the inside temperature kept at 135° C. in such a manner that the MD direction coincides with the gravity direction, and the sample is subjected to a heat treatment in which the sample is left to stand in a tensionless state for 30 minutes. A length of the sample is measured in the MD direction before and after the heat treatment. A thermal shrinkage rate (%) in the MD direction is then calculated from the following equation. Details of the measurement method (3) are as described in Examples.

Thermal shrinkage rate (%) in MD direction=(length in MD direction before heat treatment−length in MD direction after heat treatment)÷length in MD direction before heat treatment×100

In the present disclosure, the thermal shrinkage rate of the separator in the MD direction, which is measured by the method (3), is referred to as a “MD-direction thermal shrinkage rate at 135° C”.

An MD-direction thermal shrinkage rate of 3% or more at 135° C. indicates that the porous substrate has extendability. When the porous substrate has extendability, the porous substrate and a composite film (sheet having a porous layer on one side or both sides of the porous substrate) are flexibly extended and shrunk in various steps (particularly, a step including application of a coating liquid while applying a tension to the porous substrate and a drying step including application of heat for removal of a solvent or water) in production of the separator, so that creases and streaks are less likely to occur in the separator roll, and resultantly, the battery element and the battery are less likely to cause a poor appearance. The MD-direction thermal shrinkage rate at 135° C. is preferably 40% or less from the viewpoint of thermal dimensional stability of the separator which is related to safety of the battery.

From the above-mentioned points of view, the lower limit of the MD-direction thermal shrinkage rate at 135° C. is preferably 3% or more, more preferably 5% or more, and still more preferably 10% or more, and the upper limit of the MD-direction thermal shrinkage rate at 135° C. is preferably 40% or less, more preferably 30% or less, and still more preferably 25% or less.

Hereinafter, details of the porous substrate and the porous layer of the separator wound as the separator roll of the present disclosure will be described.

[Porous Substrate]

In the present disclosure, the porous substrate means a substrate having voids or gaps therein. Examples of the substrate include microporous films; porous sheets composed of fibrous materials such as nonwoven fabrics and papers; and composite porous sheets having, on a microporous film or a porous sheet, one or more other porous layers disposed thereon. The microporous film is preferable as the porous substrate from the viewpoint of thinning and strength of the separator. The microporous film means a film which has a large number of micropores therein, with the micropores being linked together to allow a gas or liquid to pass from one side to the other side.

The porous substrate includes an organic material and/or inorganic material having electric insulation property.

The porous substrate preferably includes a thermoplastic resin from the viewpoint of imparting a shutdown function to the porous substrate. The shutdown function is such a function that in a case in which the battery temperature increases, the material is melt to close the pores of the porous substrate, so that movement of ions is blocked to prevent thermal runaway of the battery.

One example of the thermoplastic resin contained in the porous substrate is a thermoplastic resin having a melting temperature lower than 200° C. A porous substrate containing a thermoplastic resin having a melting temperature lower than 200° C. is more easily extended in MD direction under tension as compared to a porous substrate which does not contain such a resin. Thus, conventionally, a separator prepared using a porous substrate containing a thermoplastic resin having a melting temperature lower than 200° C. easily shrinks in the MD direction at room temperature. According to the technique of the present disclosure, a separator and a separator roll which is less likely to cause winding displacement and deformation of a battery element even in a case in which a porous substrate containing a thermoplastic resin having a melting temperature lower than 200° C. is used may be provided.

In the present disclosure, the thermoplastic resin which is contained in the porous substrate and has a melting temperature lower than 200° C. is preferably a polyolefin.

The porous substrate is preferably a microporous film including a polyolefin (also referred to as a “polyolefin microporous film”). It is preferable that as a polyolefin microporous film, one having sufficient dynamic characteristics and ion permeability is selected from polyolefin microporous films that are applied in conventional separators for a battery.

The polyolefin microporous film preferably includes polyethylene from the viewpoint of exhibiting a shutdown function. A content of polyethylene therein is preferably 95% by mass or more.

The polyolefin microporous film is preferably a polyolefin microporous film containing polyethylene and polypropylene from the viewpoint of imparting such heat resistance that the film is not easily broken when exposed to a high temperature. Examples of the polyolefin microporous film include microporous films in which polyethylene and polypropylene coexist in one layer. Preferably, the microporous film contains polyethylene in an amount of 95% by mass or more and polypropylene in an amount of 5% by mass or less from the viewpoint of attaining both a shutdown function and heat resistance. From the viewpoint of attaining both a shutdown function and heat resistance, it is also preferable that the polyolefin microporous film has a layered structure including two or more layers in which at least one layer contains polyethylene, and at least one layer contains polypropylene.

The polyolefin contained in the polyolefin microporous film is preferably a polyolefin having a weight average molecular weight of from 100,000 to 5,000,000. When the weight average molecular weight is 100,000 or more, sufficient dynamic characteristics may be secured. When the weight average molecular weight is 5,000,000 or less, shutdown characteristics becomes favorable, and formation of the film becomes easy.

The polyolefin microporous film can be produced by, for example, the following method. That is a method including extruding a melt polyolefin resin from a T-die to make the resultant into a sheet, subjecting the sheet to a crystallization treatment, stretching, and treating with heat to obtain a microporous film. An alternative method includes extruding a polyolefin resin melted together with a plasticizer such as liquid paraffin from a T-die, cooling the resultant to make it into a sheet, stretching, extracting the plasticizer therefrom, and treating the sheet with heat to obtain a microporous film.

Examples of the porous sheet composed of a fibrous material include nonwoven fabrics and papers composed of fibrous materials formed of resins of various types, examples of which including: polyesters such as polyethylene terephthalate; polyolefins such as polyethylene and polypropylene; and heat-resistant resins such as aromatic polyamide, polyimide, polyether sulfone, polysulfone, polyether ketone and polyether imide. Here, the heat-resistant resin is a polymer having a melting temperature of 200° C. or higher, or a polymer which has no melting temperature but has a decomposition temperature of 200° C. or higher.

Examples of the composite porous sheet include a sheet having a functional layer disposed on a microporous film or a porous sheet. The composite porous sheet is preferable in view of enabling provision of an additional function by way of the functional layer. The functional layer is preferably a porous layer containing a heat-resistant resin or a porous layer containing a heat-resistant resin and an inorganic filler from the viewpoint of imparting heat resistance. Examples of the heat-resistant resin include one or more heat-resistant resins selected from an aromatic polyamide, a polyimide, a polyether sulfone, a polysulfone, a polyether ketone or a polyether imide. Examples of the inorganic filler include a metal oxide such as alumina, and a metal hydroxide such as magnesium hydroxide. Examples of the method of providing a functional layer on a microporous film or a porous sheet include: a method in which a microporous film or a porous sheet is coated with a functional layer; a method in which a microporous film or a porous sheet and a functional layer are bound to each other with an adhesive; and a method in which a microporous film or a porous sheet and a functional layer are bonded to each other by heat-pressing.

A thickness of the porous substrate is preferably from 5 μm to 30 μm from the viewpoint of obtaining favorable dynamic characteristics and internal resistance.

A Gurley value (JIS P8117 (2009)) of the porous substrate is preferably from 50 seconds/100 cc to 800 seconds/100 cc from the view point of preventing a short-circuit of a battery and obtaining ion permeability.

A porosity of the porous substrate is preferably from 20% to 60% from the viewpoint of obtaining suitable film resistance and a suitable shutdown function.

A piercing strength of the porous substrate is preferably 300 g or more from the viewpoint of improving the production yield.

[Porous Layer]

In the present disclosure, the porous layer is a layer which has a large number of micropores therein, with the micropores being linked together and allowing a gas or liquid to pass from one side to the other side. In the present disclosure, the porous layer is a layer which is provided on one or both sides of the porous substrate as an outermost layer of the separator

The porous layer is preferably an adhesive porous layer which is bound to an electrode. Preferably, the porous layer exists on not only one side, but on both sides of the porous substrate for the battery to have excellent cycle characteristics. When the porous layer exists on both sides of the porous substrate, both sides of the separator are well bound to both electrodes with the porous layer interposed therebetween.

A porosity of the porous layer is preferably from 30% to 80%, and more preferably 50% to 80% from the viewpoint of ion permeability and dynamic strength.

A coating amount of the porous layer is preferably from 0.5 g/m² to 3.0 g/m² on one side of the porous substrate from the viewpoint of ion permeability and adherence to an electrode. In a case in which the porous layer is provided on both sides of the porous substrate, the coating amount of the porous layer is preferably from 1.0 g/m² to 6.0 g/m² as a total amount of the porous layer on both sides.

An average thickness of the porous layer is preferably from 0.5 μm to 5μm on one side of the porous substrate from the viewpoint of securing a high energy density and adherence to an electrode.

The porous layer is a layer obtained by solidifying a coating layer formed by coating the porous substrate with a coating liquid containing at least one of a resin or an inorganic particle. Thus, the porous layer contains at least one of the resin or the inorganic particle. Hereinafter, details of the resin and the inorganic particle contained in the coating liquid and the porous layer will be described.

[Resin]

The resin contained in the porous layer is preferably one that is stable to an electrolytic solution, and electrochemically stable, has a function of connecting inorganic particles, and is capable of bonding to an electrode. The porous layer may contain only one resin, or two or more resins.

The resin contained in the porous layer is preferably an adhesive resin from the viewpoint of adherence to an electrode. Since the separator and the electrode are in close contact with each other with an adhesive resin-containing porous layer interposed therebetween, winding displacement and deformation of the battery element is still less likely to occur.

Examples of the adhesive resin include polyvinylidene fluoride, polyvinylidene fluoride copolymers, styrene-butadiene copolymers, homopolymers or copolymers of vinyl nitrile such as acrylonitrile and methacrylonitrile, and polyethers such as polyethylene oxide and polypropylene oxide. Among them, polyvinylidene fluoride and polyvinylidene fluoride copolymers (they are also referred to as “polyvinylidene fluoride resins”) are particularly preferable.

Examples of the polyvinylidene fluoride resin contained in the porous layer include a homopolymer of vinylidene fluoride (i.e. polyvinylidene fluoride); a copolymer of vinylidene fluoride and other copolymerizable monomer (polyvinylidene fluoride copolymers); and mixtures thereof.

Examples of the monomer polymerizable with vinylidene fluoride include tetrafluoroethylene, hexafluoropropylene, trifluoroethylene, trichloroethylene and vinyl fluoride, one of which or two or more of which may be employed.

The polyvinylidene fluoride resin may be obtained by emulsification polymerization or suspension polymerization.

The resin contained in the porous layer is preferably a heat-resistant resin (a resin having a melting temperature of 200° C. or higher, or a resin having no melting temperature and having a decomposition temperature of 200° C. or higher) from the viewpoint of heat resistance. Examples of the heat-resistant resin include polyamide, fully aromatic polyamide, polyimide, polyamidimide, polysulfone, polyketone, polyether ketone, polyether sulfone, polyether imide, cellulose, and mixtures thereof. Among them, fully aromatic polyamide is preferable from the viewpoint of ease of forming a porous structure, binding property with inorganic particles, oxidation resistance and so on. Among fully aromatic polyamides, meta-type fully aromatic polyamide is preferable, and polymetaphenylene isophthalamide is particularly preferable from the viewpoint of ease of forming a porous layer.

[Inorganic Particle]

The inorganic particle is preferably one that is stable to an electrolytic solution and which is electrochemically stable. The inorganic particle may be used singly, or in combination of two or more kinds thereof.

Examples of the inorganic particle include: metal hydroxides such as aluminum hydroxide, magnesium hydroxide, calcium hydroxide, chromium hydroxide, zirconium hydroxide, cerium hydroxide, nickel hydroxide and boron hydroxide; metal oxides such as silica, alumina, zirconia and magnesium oxide; carbonates such as calcium carbonate and magnesium carbonate; sulfates such as barium sulfate and calcium sulfate; and clay minerals such as calcium silicate and talc. Among them, metal hydroxides and metal oxides are preferable from the viewpoint of an electricity eliminating effect and impartment of flame retardancy. The inorganic particle may be one that is surface-modified with a silane coupling agent.

The particle shape of the inorganic particle may be arbitrarily selected, and may be any of a spherical shape, an oval shape, a plate shape, a rod shape and an undefined shape. The inorganic particle is preferably a plate-shaped particle or a primary particle that is not aggregated from the viewpoint of preventing a short-circuit of the battery. A volume average particle size of the inorganic particle as a primary particle is preferably from 0.01 μm to 10 μm, and more preferably from 0.1 μm to 10 μm from the viewpoint of excellent adherence to an electrode, ion permeability, slippage, and formability of a porous layer.

Preferably, the porous layer contains at least a resin from the view point of adherence to an electrode. Preferably, the porous layer further contains an inorganic particle from the viewpoint of heat resistance. In a case in which the porous layer contains a resin and an inorganic particle, a ratio of the inorganic particle to a total amount of the resin and the inorganic particle is, for example, from 30% by volume to 90% by volume.

The porous layer may contain an organic filler and/or other component(s). Examples of the organic filler include particles of crosslinked polymers such as crosslinked poly(meth)acrylic acid, crosslinked poly(meth)acrylic acid ester, crosslinked polysilicone, crosslinked polystyrene, crosslinked polydivinylbenzene, crosslinked products of styrene-divinylbenzene copolymer, polyimide, melamine resin, phenol resin and benzoguanamine-formaldehyde condensates; and particles of heat-resistant resins such as polysulfone, polyacrylonitrile, aramid, polyacetal and thermoplastic polyimide.

[Properties of Separator]

In the present disclosure, a Gurley value (JIS P8117 (2009)) of the separator is preferably from 50 seconds/100 cc to 800 seconds/100 cc because the balance between mechanical strength and film resistance is improved thereby.

In the separator of the present disclosure, the value obtained by subtracting the Gurley value of the porous substrate from the Gurley value of the separator with the porous layer provided on the porous substrate is preferably 300 seconds/100 cc or less, more preferably 150 seconds/100 cc or less, and still more preferably 100 seconds/100 cc or less from the viewpoint of ion permeability.

In the present disclosure, a thickness of the separator is preferably from 5 μm to 40 μm, more preferably from 5 μm to 35 μm, and still more preferably 10 μm to 20 μm from the viewpoint of mechanical strength and the energy density when the separator is applied to a battery.

[Method of Producing Separator Roll]

The separator roll of the present disclosure includes a primary roll obtained by winding the separator directly around a core after production of the separator, and a secondary roll obtained by winding, around another core, the separator taken from the primary roll. The secondary roll includes a roll obtained by winding the separator taken directly from the primary roll, and a roll obtained by winding the separator fed from the primary roll with slitting the separator to a desired width.

The core of the primary roll and the core of the secondary roll may be of the same kind, or may be of different kinds from each other. Both the cores are not particularly limited, and examples thereof include known cores around which a long sheet can be wound.

Examples of the material of the core include resins, papers and metals. One embodiment of the core is a core having a groove and/or a slit on an outer peripheral surface thereof. One embodiment of the core is a core having on an outer peripheral surface thereof an elastic layer (e.g. a rubber layer) for suppressing damage to a sheet to be wound thereon.

A length of the core in an axial direction is not particularly limited as long as it is equal to or larger than a width of a sheet to be wound, while the length of the core in an axial direction is preferably larger by from 0 cm to 50 cm than a width of a sheet to be wound. An outer diameter of the core is preferably from 7 cm to 30 cm.

In the present disclosure, the separator is a separator with a porous layer provided on one side or both sides of a porous substrate. The porous layer is a layer obtained by solidifying a coating layer formed by coating one side or both sides of a porous substrate with a coating liquid. The coating liquid contains at least one of a resin or an inorganic particle.

Examples of a method for providing the porous layer on the porous substrate include: a dry production method in which a coating layer is formed by coating a porous substrate with a coating liquid, and then dried to solidify the coating layer, thereby providing a porous layer; and a wet production method in which a coating layer is formed by coating a porous substrate with a coating liquid, and then the coating layer is brought into contact with a coagulation liquid to solidify the coating layer, thereby providing a porous layer. Since a porous layer provided by the dry production method is apt to be denser than a porous layer provided by the wet production method, the wet production method is more preferable in that a favorable porous structure can be obtained.

Preferably, the wet production method includes: a coating liquid preparing step of preparing a coating liquid containing a resin; an application step of forming a coating layer by applying one side or both sides of a porous substrate with the coating liquid; a coagulation step of bringing the coating layer into contact with a coagulation liquid to coagulate the resin contained in the coating layer, thereby obtaining a composite film (sheet having a porous layer on one side or both sides of the porous substrate); a rinsing step of rinsing the composite film with water; and a drying step of drying the composite film. An inorganic particle may be further dispersed in the coating liquid.

Preferably, the dry production method includes a coating liquid preparing step of preparing a coating liquid containing a resin; a coating step of forming a coating layer by coating one side or both sides of a porous substrate with the coating liquid; and a coagulation step of removing a solvent contained in the coating layer to coagulate the resin contained in the coating layer, thereby obtaining a composite film (sheet having a porous layer on one side or both sides of the porous substrate). An inorganic particle may be further dispersed in the coating liquid.

Details of the steps in the wet production method and the dry production method are as follows.

—Coating Liquid Preparing Step—

The coating liquid preparing step is a step of preparing a coating liquid containing a resin. The coating liquid is prepared by, for example, dissolving a resin in a solvent, and further dispersing an inorganic particle if necessary.

As the solvent which is used for preparation of the coating liquid and in which the resin is dissolved (hereinafter, also referred to as a “good solvent”), a polar amide solvent such as N-methylpyrrolidone, dimethylacetamide, dimethylformamide or dimethylformamide is preferably used.

Preferably, a phase separation agent which induces phase separation is mixed with the good solvent from the viewpoint of forming a porous layer having a favorable porous structure. Examples of the phase separation agent include water, methanol, ethanol, propyl alcohol, butyl alcohol, butanediol, ethylene glycol, propylene glycol and tripropylene glycol. Preferably, the phase separation agent is mixed with a good solvent in an amount in a range which ensures that a viscosity suitable for coating can be secured.

The solvent to be used for preparation of the coating liquid is preferably a mixed solvent containing the good solvent in an amount of 60% by mass or more and the phase separation agent in an amount of from 10% by mass to 40% by mass from the viewpoint of forming a favorable porous structure.

Preferably, the coating liquid contains the resin in a concentration of from 3% by mass to 10% by mass with respect to the total mass of the coating liquid from the viewpoint of forming a favorable porous structure.

—Application Step—

The application step is a step of forming a coating layer by applying one side or both sides of a porous substrate with a coating liquid containing a resin. Examples of means for coating a porous substrate with a coating liquid include a Meyer bar, a die coater, a reverse roll coater and a gravure coater. In a case in which the porous layer is formed on both surfaces of the porous substrate, it is preferable to simultaneously coat the both surfaces with the coating liquid from the viewpoint of productivity.

—Coagulation Step—

In the wet production method, the coagulation step is a step of bringing the coating layer into contact with a coagulation liquid to coagulate the resin contained in the coating layer, thereby obtaining a composite film. As a method for bringing the coating layer into contact with the coagulation liquid, it is preferable that the porous substrate having the coating layer is immersed in the coagulation liquid, specifically the porous substrate is made to pass through a bath (coagulation bath) containing the coagulation liquid.

The coagulation liquid generally contains water, and the good solvent and phase separation agent used for preparation of the coating liquid. From the viewpoint of production, it is preferable that a mixing ratio of the good solvent and the phase separation agent thereof is made consistent with a mixing ratio of the good solvent and the phase separation agent of the mixed solvent used for preparation of the coating liquid. A content of water in the coagulation liquid is preferably from 40% by mass to 80% by mass from the viewpoint of productivity and formation of a porous structure. A temperature of the coagulation liquid is, for example, from 20° C. to 50° C.

In the dry production method, the coagulation step is a step of removing a solvent contained in the coating layer by drying to coagulate the resin contained in the coating layer, thereby obtaining a composite film. In the dry production method, a method for removing a solvent from the composite film is not limited, and examples thereof include: a method in which the composite film is brought into contact with a heat generation member; and a method in which the composite film is conveyed into a chamber having a controlled temperature and humidity.

—Rinsing Step—

In the wet production method, the rinsing step is a step of rinsing the composite film with water in order to remove a solvent contained in the composite film (a solvent contained in the coating liquid and a solvent contained in the coagulation liquid). Specifically, the rinsing step is carried out preferably by conveying the composite film through the inside of a bath (rinsing bath) containing water. The temperature of the water for rinsing is, for example, from 20° C. to 50° C.

—Drying Step—

The drying step is a step which is carried out in order to remove water from the rinsed composite film after the rinsing step. The drying method is not limited, and examples thereof include: a method in which the composite film is brought into contact with a heat generation member; a method in which the composite film is conveyed into a chamber having a controlled temperature and humidity; and a method in which hot air is applied to the composite film. In a case in which heat is applied to the composite film, a temperature thereof is, for example, from 50° C. to 80° C.

The primary roll is produced by winding a separator directly around a core, the separator being produced by carrying out the above-mentioned steps in order. The secondary roll is produced by further winding the separator taken from the primary roll. In production of the primary roll, the separator winding speed is, for example, from 10 m/min to 100 m/min, and preferably from 40 m/min to 100 m/min in view of productivity. In production of the secondary roll, the separator winding speed is, for example, from 10 m/min to 200 m/min, and more preferably from 50 m/min to 200 m/min in view of productivity.

In the steps in the wet production method or the dry production method, it is preferable to apply the following conditions (a) to (g) from the viewpoint of producing a separator which has a favorable appearance and in which creases are reduced while controlling the MID-direction shrinkage rate at 25° C. to 1.0% or less.

(a) A porous substrate having small internal stress is used for production of the separator. Thus, in the present disclosure, a firmly heat-set porous substrate is preferable.

(b) A draw rate at the time of applying the porous substrate with a coating liquid (rate of a conveyance speed at the end of coating with respect to a conveyance speed at the start of coating) is made as small as possible.

(c) A conveyance resistance to a conveyance object which occurs in passage of the conveyance object through the coagulation bath and the rinsing bath is high. Therefore, the porous substrate is easily extended, and as a result, creases may occur in the separator. For suppressing this, a temperature of each of the coagulation liquid and water in the rinsing bath is made as low as possible. The temperature of each of the coagulation liquid and water in the rinsing bath is preferably 40° C. or lower, more preferably 35° C. or lower, and still more preferably about 25° C.

(d) In a case in which heat is applied to the composite film in the drying step, a relaxation step of bringing the composite film into contact with a roll member etc. is further provided for suppressing a change in dimension of the composite film due to thermal shrinkage.

(e) A decrease in a draw rate (rate of a conveyance speed at the end of a step with respect to a conveyance speed at the start of the step) in each step has a trade-off relationship with occurrence of creases in a conveyance object, and therefore when the draw rate in each step is simply decreased, creases easily occur in the porous substrate and the separator. As a contrivance in conveyance, for example, only drive rolls are used as conveyance rolls; a distance between conveyance rolls is reduced; or an expander or a pinch roll for getting rid of creases is installed. Particularly, a pinch roll is installed immediately before coating because a tension is most greatly applied to the porous substrate at the time of coating the porous substrate with the coating liquid.

(f) A speed rate (%) of a separator winding speed to a porous substrate feeding speed (separator winding speed÷porous substrate feeding speed×100) (referred to as a “total draw rate”) is made as small as possible. The total draw rate is preferably 103% or less, more preferably 102% or less, but the total draw rate is preferably 100% or more.

(g) A tension that is applied to the separator at the time of winding the separator around a core is made as low as possible. However, when the tension is excessively low, creases occur in the separator. Therefore it is desired to employ a contrivance in conveyance which is similar to that in (e).

After the separator is wound around the core, the MID-direction shrinkage rate at 25° C. can be controlled to 1.0% or less under the conditions (h) to (k).

(h) The primary roll is subjected to a heat treatment (annealing) in which the roll is left in a heat environment. An annealing temperature (temperature in heat environment) is preferably from 40° C. to 110° C., and more preferably from 50° C. to 90° C. It is to be noted that when the annealing temperature is higher than 90° C., a resin contained in the porous substrate is partially melted, or a blocking phenomenon occurs in which the separators sticks to each other. A treatment time (time of leaving under the heat environment) is preferably as long as possible. The treatment time is, for example, 12 hours or more.

(i) In a case in which the separator fed from the primary roll is wound around a core while being slitted, thereby producing the secondary roll, a tension applied to the separator at the time of feeding the separator from the primary roll and a tension applied to the separator at the time of winding the separator around the core are made as low as possible. However, it is necessary to both the tensions are applied to a certain degree for obtaining a separator having a favorable appearance at the slit end.

(j) In production of the secondary roll, it is preferable to apply a contact pressure to the separator with a roll member (i.e. a contact roll) immediately before winding in order to wind the separator around the core without causing creases to occur in the separator, and in this case, the contact pressure of the roll member is made as low as possible.

(k) The secondary roll is subjected to a heat treatment (annealing) in which the roll is left in a heat environment. Attention should be given to a temperature and treatment time of the heat treatment because the heat treatment may cause a sag at both ends of the separator in the transverse direction. The temperature is preferably from 40° C. to 70° C., and more preferably from 40° C. to 60° C. The treatment time is, for example, from 1 hour to 48 hours.

As a method for producing the separator roll of the present disclosure, mention is made of the following embodiment as a preferred example.

One embodiment of the method for producing the separator roll is a production method including providing a porous layer on one side or both sides of a porous substrate by a wet production method. In this method, a temperature of a coagulation liquid is 40° C. or lower (preferably 35° C. or lower, and more preferably about 25° C.).

One embodiment of the method for producing the separator roll includes winding a separator around a core at a winding speed of 103% or less (preferably from 100% to 103%, more preferably from 100% to 102%) of a feeding speed of the porous substrate. According to this embodiment, a primary roll in which creases are reduced and which has a favorable winding appearance is easily prepared, and a shrinkage rate after processing the primary roll into a secondary roll is easily kept low.

One embodiment of the method for producing the separator roll includes leaving a roll, which is obtained by winding a separator directly around a core after production of the separator, to stand in an atmosphere of from 40° C. to 110° C. for 12 hours or more (e.g. 24 hours). According to this embodiment, closure of the porous structures of the porous substrate and the coating layer can be suppressed. Particularly, in a case in which the coating layer is one that contains an adhesive resin, a blocking phenomenon (phenomenon in which stacked separators in the separator roll stick to each other), and closure of the porous structure of the coating layer can be suppressed. Preferably, one embodiment of the method for producing the separator roll includes leaving the roll to stand in an atmosphere of from 50° C. to 80° C. for 12 hours or more (e.g. 24 hours).

As the separator roll of the present disclosure, mention is made of the following embodiment as a preferred example.

In one embodiment of the separator roll, the porous layer of the separator is a porous layer provided on one side or both sides of a porous substrate by a wet production method. The porous layer is formed by bringing a coating layer into contact with a coagulation liquid at a temperature of 40° C. or lower (preferably 35° C. or lower, more preferably about 25° C.) to solidify a resin in the coating layer.

One embodiment of the separator roll is a primary roll obtained by winding a separator directly around a core after production of the separator, or a secondary roll obtained by winding, around a core, the separator fed from the primary roll, and the primary roll is a roll obtained by winding the separator around a core at a total draw rate of 103% or less (preferably from 100% to 103%, and more preferably from 100% to 102%). According to this embodiment, closure of the porous structures of the porous substrate and the coating layer can be suppressed. Particularly, in a case in which the coating layer is one that contains an adhesive resin, a blocking phenomenon and closure of the porous structure of the coating layer can be suppressed.

One embodiment of the separator roll is a primary roll obtained by winding a separator directly around a core after production of the separator, or a secondary roll obtained by winding, around a core, the separator taken from the primary roll, in which the primary roll is a roll left in an atmosphere from 40° C. to 110° C. (preferably from 50° C. to 80° C.) for 12 hours or more (e.g. 24 hours). According to this embodiment, closure of the porous structures of the porous substrate and the coating layer can be suppressed. Particularly, in a case in which the coating layer is one that contains an adhesive resin, a blocking phenomenon and closure of the porous structure of the coating layer can be suppressed.

One embodiment of the primary roll is a roll obtained by winding a separator with a width of, for example, from 200 mm to 2000 mm over a length of not less than 100 m but not more than 3000 m.

One embodiment of the secondary roll is a roll obtained by winding a separator with a width of, for example, from 15 mm to 500 mm over a length of not less than 100 m but not more than 2500 m.

In one embodiment of the separator roll, the diameter of the separator roll is, for example, from 15 cm to 30 cm.

The separator roll of the present disclosure can be used for production of a primary battery and a secondary battery. Hereinafter, an exemplary embodiment in which a separator wound as the separator roll of the present disclosure is applied to a secondary battery will be described.

<Non-aqueous Secondary Battery>

A non-aqueous secondary battery of the present disclosure is a non-aqueous secondary battery which produces an electromotive force by doping/de-doping of lithium, the non-aqueous secondary battery including a positive electrode, a negative electrode, and a separator supplied from the separator roll of the present disclosure. A non-aqueous secondary battery has a structure in which a battery element is enclosed in an outer packaging material, the battery element which includes a structural body that has a negative electrode and a positive electrode facing each other with a separator interposed therebetween and that is impregnated with an electrolytic solution. The doping means absorption, holding, adsorption or insertion, which means a phenomenon in which lithium ions enter an active material of an electrode such as a positive electrode.

The non-aqueous secondary battery of the present disclosure is suitable as a non-aqueous electrolyte secondary battery, particularly a lithium ion secondary battery.

Since the non-aqueous secondary battery of the present disclosure is produced using a separator supplied from the separator roll of the present disclosure, winding displacement is less likely to occur in production of its battery element. Further, since the non-aqueous secondary battery of the present disclosure includes a separator supplied from the separator roll of the present disclosure, the battery element is less likely to deform. Thus, the non-aqueous secondary battery of the present disclosure is excellent in production yield of batteries.

In the non-aqueous electrolyte secondary battery of the present disclosure, exemplary embodiment of the positive electrode includes a structure in which an active material layer containing a positive electrode active material and a binder resin is formed on a current collector. The active material layer may further contain a conductive assistant. Examples of the positive electrode active material include lithium-containing transition metal oxides, specific examples of which including LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂ and LiAl_{1/4}Ni_{3/4}O₂. Examples of the binder resin include polyvinylidene fluoride resins. Examples of the conductive assistant include carbon materials such as acetylene black, ketjen black and graphite powders. Examples of the current collector include aluminum foils, titanium foils and stainless foils having a thickness of, for example, from 5 μm to 20 μm.

In the non-aqueous electrolyte secondary battery of the present disclosure, exemplary embodiment of the negative electrode includes a structure in which an active material layer containing a negative active material and a binder resin is formed on a current collector. The active material layer may further contain a conductive assistant. Examples of the negative active material include materials capable of electrochemically absorbing lithium, specific examples of which including carbon materials; and alloys of lithium and silicon, tin, aluminum or the like. Examples of the binder resin include polyvinylidene fluoride resins and styrene-butadiene rubbers. Examples of the conductive assistant include carbon materials such as acetylene black, ketjen black and graphite powders. Examples of the current collector include copper foils, nickel foils and stainless foils having a thickness of, for example, from 5 μm to 20 μm. Alternatively, in place of the negative electrode described above, a metal lithium foil may be used as a negative electrode.

In the non-aqueous electrolyte secondary battery of the present disclosure, exemplary embodiment of the electrolytic solution includes a solution obtained by dissolving a lithium salt in a non-aqueous solvent. Examples of the lithium salt include LiPF₆, LiBF₄ and LiClO₄. Examples of the non-aqueous solvent include cyclic carbonates such as ethylene carbonate, propylene carbonate, fluoroethylene carbonate anddifluoroethylene carbonate; chain carbonates such as dimethyl carbonate, diethyl carbonate, ethylmethyl carbonate and fluorine-substituted products thereof; and cyclic esters such as γ-butyrolactone and γ-valerolactone. They may be used singly, or in combination of two or more kinds thereof. The electrolytic solution is preferably one obtained by mixing a cyclic carbonate and a chain carbonate at a mass ratio (cyclic carbonate:chain carbonate) of from 20:80 to 40:60, and dissolving a lithium salt therein in an amount of from 0.5 M to 1.5 M.

Examples of an outer packaging material of the non-aqueous electrolyte secondary in the present disclosure include metal cans and aluminum laminated film packages. Examples of a shape of the non-aqueous electrolyte secondary battery of the present disclosure include a rectangular shape, a flat shape, a circular-cylindrical shape and a coin shape, and the separator of the present disclosure is suitable for any shape.

The method for producing the non-aqueous secondary battery of the present disclosure is not particularly limited. The battery element of the non-aqueous secondary battery of the present disclosure is produced by, for example, a method in which a positive electrode, a separator, a negative electrode and a separator are superimposed one on another in this order, and a resultant thereof is wound in its length direction.

As an exemplary embodiment of the non-aqueous secondary battery of the present disclosure, mention is made of a battery produced using a separator having a porous layer containing an adhesive resin. In the non-aqueous secondary battery, the separator and the electrode are in close contact with each other with an adhesive resin-containing porous layer interposed therebetween. Therefore, winding displacement and deformation of the battery element becomes less likely to occur, resulting in further improvement of production yield of batteries.

### EXAMPLES

The separator roll and the non-aqueous secondary battery of the present disclosure will be described further in detail below by way of Examples. The separator roll and the non-aqueous secondary battery of the present disclosure are not limited to Examples below. The method for measurement of a film/layer thickness and a method for measurement of the Gurley value in Examples are as follows.

[Thickness]

A thickness (μm) of each of the porous substrate and the composite film was determined by measuring the thickness at 20 randomly selected spots within an area of 10 cm ×30 cm using a contact-type thickness meter (LITEMATIC manufactured by Mitutoyo Corporation), and averaging the measured values. A measurement was made under the condition of a load of 7 g using a circular-cylindrical measurement terminal with a diameter of 5 mm.

[Gurley Value]

The Gurley value (seconds/100 cc) of the porous substrate was measured using a Gurley-type Densometer (G-B2C manufactured by Toyo Seiki Sesaku-Sho) in accordance with JIS P8117 (2009).

### Example 1

A resin obtained by mixing KF POLYMER #9300 (manufactured by Kureha Corporation) and KYNAR 2801 (manufactured by Arkema Company) at a mass ratio of 50:50 as a polyvinylidene fluoride resin (PVDF resin) was dissolved in a solvent (dimethylacetamide:tripropylene glycol=70:30 in terms of a mass ratio) to prepare a coating liquid having a PVDF resin concentration of 5% by mass. Both surfaces of a porous substrate (polyethylene microporous film TN 0901 manufactured by SK Company, thickness: 9 μm, Gurley value: 150 seconds/100 cc) were coated with the coating liquid in an equal amount to form a coating layer on both surfaces of the porous substrate. The porous substrate provided with the coating layers was immersed in a coagulation liquid (water : dimethylacetamide:tripropylene glycol=62.5:30:7.5 in terms of a mass ratio, temperature: 35° C.) to solidify the coating layer, thereby obtaining a composite film with a porous layer provided on both surfaces of a polyethylene microporous film. Subsequently, the composite film was rinsed with water, dried, and wound around a core (made of paper, inner diameter: 15 cm, outer diameter: 18 cm) by 500 m, and the resulting roll was subjected to a heat treatment in which the roll was left to stand in an atmosphere at 75° C. for 24 hours, thereby obtaining a primary roll. A total draw rate in production of the primary roll was defined as 102.0%.

The primary roll was then left to stand at room temperature to be cooled, and the separator taken out of the primary roll was then wound around a core (made of synthetic resin, inner diameter: 7.6 cm, outer diameter: 20 cm) by 400 m while being slitted to a width of 100 mm, thereby obtaining a secondary roll of 100 mm×400 m.

### Example 2

Except that the condition for the heat treatment of the primary roll was changed such that the roll was left to stand at 50° C. for 24 hours, the same procedure as in Example 1 was carried out to obtain a primary roll and a secondary roll.

### Example 3

Except that the condition for the heat treatment of the primary roll was changed such that the roll was left to stand at 50° C. for 24 hours, and the total draw rate in production of the primary roll was changed to 103.0%, the same procedure as in Example 1 was carried out to obtain a primary roll and a secondary roll.

### Example 4

Polymetaphenylene isophthalamide (PMIA) (CONEX manufactured by Teijin Techno Products Limited) was dissolved in a solvent (dimethylacetamide:tripropylene glycol =70:30 in terms of a mass ratio) to prepare a solution having a PMIA concentration of 5% by mass. In this solution, α-alumina (SA-1 manufactured by Iwatani Chemical Industry Co., Ltd., average particle size: 0.8 μm) was dispersed as an inorganic particle in such a manner that a mass ratio of α-alumina:PMIA was 50:50, thereby obtaining a coating liquid. Except that the coating liquid was used in place of that used in Example 1, the same procedure as in Example 1 was carried out to obtain a primary roll and a secondary roll.

### Example 5

Except that the total draw rate in production of the primary roll was changed to 103.0%, the same procedure as in Example 4 was carried out to obtain a primary roll and a secondary roll.

### Example 6

An aramid fiber nonwoven fabric having a thickness of 30 μm was prepared in accordance with a method for production of an aramid fiber nonwoven fabric as disclosed in Japanese Patent Application Laid-Open (JP-A) No. 2013-139652. Except that the aramid fiber nonwoven fabric was used as the porous substrate, and the total draw rate was changed to 100.2%, the same procedure as in Example 4 was carried out to obtain a primary roll and a secondary roll.

### Example 7

A polyethylene terephthalate (PET) fiber nonwoven fabric having a thickness of 30 μm was used as a porous substrate. A resin obtained by mixing KF POLYMER #9300 (manufactured by Kureha Corporation) and KYNAR 2801 (manufactured by Arkema Company) at a mass ratio of 50:50 was used as a polyvinylidene fluoride resin (PVDF resin). The PVDF resin was dissolved in a solvent (dimethylacetamide:tripropylene glycol=70:30 in terms of a mass ratio) to prepare a solution having a resin concentration of 5% by mass. In this solution, α-alumina (SA-1 manufactured by Iwatani Chemical Industry Co., Ltd.; average particle size: 0.8 μm) was dispersed as an inorganic particle in such a manner that a mass ratio of α-alumina:PVDF resin was 50:50, thereby obtaining a coating liquid. Except that the porous substrate and the coating liquid were used in place of those used in Example 1, and the total draw rate was changed to 100.2%, the same procedure as in Example 1 was carried out to obtain a primary roll and a secondary roll.

### Comparative Example 1

Except that the condition for the heat treatment of the primary roll was changed such that the roll was left to stand at 35° C. for 24 hours, the same procedure as in Example 1 was carried out to obtain a primary roll and a secondary roll.

### Comparative Example 2

Except that the temperature of the coagulation liquid for solidifying the coating layer was changed to 50° C., the total draw rate was changed to 103.5%, and the primary roll was not subjected to a heat treatment, the same procedure as in Example 1 was carried out to obtain a primary roll and a secondary roll.

<Evaluation>

For Examples 1 to 7 and Comparative Examples 1 and 2, evaluations of the separator roll were performed as described below. Results are shown in table 1.

[Appearance of Primary Roll]

The primary roll was visually observed to determine presence/absence of creases. In observation, creases can be easily found when light is applied thereto. Therefore, the primary roll was observed with applying light thereto.

### —Evaluation Criteria—

A: The roll has no creases.

B: The roll has creases, but there is no problem in practical use.

C: The roll has many creases.

[MD-Direction Shrinkage rate and TD-Direction Enlargement rate of Separator at 25° C.]

In order to remove an outermost layer of the primary roll or the secondary roll, the separator of 5 revolutions of the separator roll starting from the outer end of the primary roll or the secondary roll was unwound, cut and removed. A piece of the separator was cut out of the remaining separator roll to have a length of 200 mm from the cut end, and the cut-out piece of the separator was used as a test piece (200 mm (MD direction)×100 mm (TD direction)).

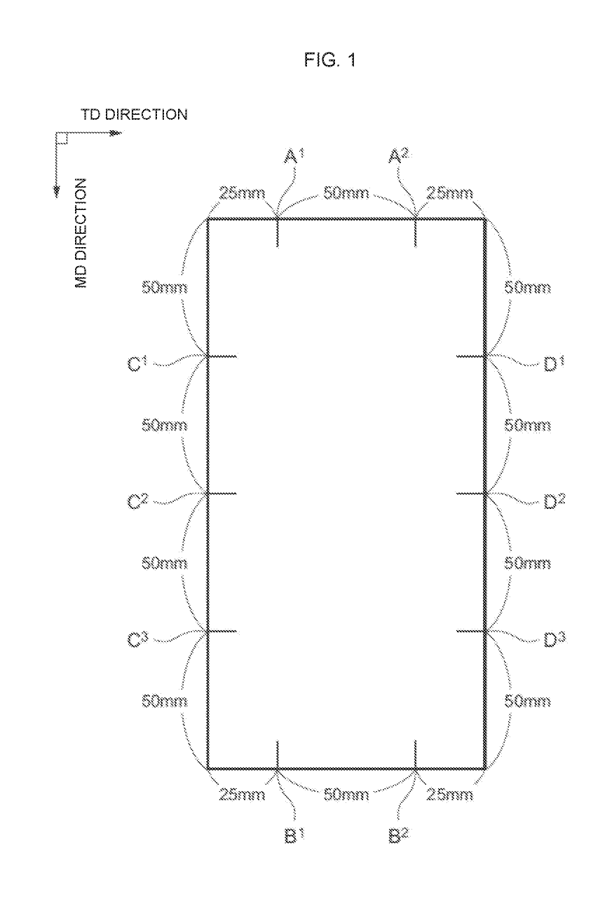

One side of the test piece was marked at the positions A₁, A², B¹, B², C¹, C², C³, D¹, D² and D³ shown in FIG. 1. One end of the test piece was held by a crip, the test piece was suspended in a thermostatic bath at a temperature of 25° C. and a relative humidity of 50±10% in such a manner that the MD direction coincided with the gravity direction, and the test piece was left to stand in a tensionless state for 24 hours.

Before and after the leaving for 24 hours, a length between points A¹ and B¹, a length between points A² and B², a length between points C¹ and D¹, a length between points C² and D² and a length between points C³ and D³ were measured, and a shrinkage rate (%) in the MD direction and an enlargement rate (%) in the TD direction were calculated from the following equation.

MD-direction shrinkage rate (%) at 25° C.={[(length between points A¹ and B¹ before leaving−length between points A¹ and B¹ after leaving)÷length between points A¹ and B¹ before leaving]+[(length between points A² and B² before leaving−length between points A² and B² after leaving)÷length between points A² and B² before leaving]}÷2×100

Namely, an average of the A¹-B¹ shrinkage rate and the A²-B² shrinkage rate was defined as a MD-direction shrinkage rate at 25° C.

TD-direction enlargement rate (%) at 25° C.=[(length between points C¹ and D¹ after leaving −length between points C¹ and D¹ before leaving)÷length between points C¹ and D¹ before leaving]−[(length between points C² and D² after leaving−length between points C² and D² before leaving)÷length between C² and D² before leaving]+[(length between C³ and D³ after leaving−length between C³ and D³ before leaving)÷length between C³ and D³ before leaving]}÷3×100

Namely, an average of the C¹-D¹ enlargement rate, the C²-D² enlargement rate and the C³-D³ enlargement rate was defined as a TD-direction enlargement rate at 25° C.

In this example, the TD-direction length of the test piece was set to 100 mm, but the TD-direction length is not limited thereto in determination of the MD-direction shrinkage rate at 25° C. and the TD-direction enlargement rate at 25° C.

In this example, from the time of starting draw-out of the separator from the outer end of the primary roll or the secondary roll to the time of starting suspending the test piece in the thermostatic bath (i.e. until starting the leaving for 24 hours) was 10 minutes or less, and the length after the leaving for 24 hours was measured immediately after the test piece was taken out from the thermostatic bath. The length of the test piece, the position of a mark such as A¹, and the length between points A¹ and B¹ etc. were measured using a glass scale manufactured by Ohyama-Kogaku Co., Ltd., and the scale was read to 0.00 mm using a magnifying glass at a magnification of 50.

[Thermal Shrinkage rate of Separator at 135° C.]

The separator was cut out to 190 mm (MD direction)×60 mm (TD direction) from the primary roll or the secondary roll, and the cut-out separator was used as a test piece. The test piece was marked at two points (referred to as point A and point B) 20 mm and 170 mm away from one end in the MD direction, respectively, on a line bisecting the test piece in the TD direction. The test piece was held by a crip at a part between point A and an end closest to point A, and suspended in an oven at 135° C. in such a manner that the MD direction was coincident with the gravity direction, and the test piece was heat-treated in a tensionless state for 30 minutes. A length between the points A and B was measured before and after the heat treatment, and a thermal shrinkage rate (%) was calculated from the following equation.

Thermal shrinkage rate (%) in MD direction=(length between points A and B before heat treatment−length between points A and B after heat treatment)÷length between points A and B before heat treatment×100

In this example, the TD-direction length of the test piece was set to 60 mm, but the TD-direction length is not limited thereto in determination of the thermal shrinkage rate at 135° C.

[Winding Displacement of Battery Element]

A battery element was prepared by superimposing a positive electrode, a separator, a negative electrode and another separator one on another in this order, and winding the resultant in the length direction using a winding apparatus, in which the separators were supplied from the secondary roll. In the winding, a tension of 300 g was applied to each of the positive electrode and the negative electrode, and a tension of 100 g was applied to the separator. After the battery element was prepared, a winding displacement (mm) between the two separators was measured. It was determined that “winding displacement occurred” in a case in which the winding displacement in the separator was 0.2 mm or more, and it was determined that “winding displacement did not occur” in a case in which the winding displacement in the separator was less than 0.2 mm. The negative electrode and positive electrode used in this test was prepared in the following manner.

—Preparation of Negative Electrode—

300 parts by mass of artificial graphite as a negative active material, 7.5 parts by mass of a water-soluble dispersion liquid which contained 40% by mass of modified product of styrene-butadiene copolymer as a binder, 3 parts by mass of carboxymethylcellulose as a thickener, and a proper amount of water were mixed by stirring in a dual arm-type mixer to prepare negative electrode slurry. The negative electrode slurry was applied to both sides of a 10 μm-thick copper foil as a negative electrode current collector, and dried, and a resultant thereof was subject to pressing to obtain a negative electrode having a negative active material layer.

—Preparation of Positive Electrode—

89.5 parts by mass of lithium cobalt oxide powder as a positive active material, 4.5 parts by mass of acetylene black as a conductive assistant, and 6 parts by mass of polyvinylidene fluoride as a binder were dissolved in N-methyl-2-pyrrolidone in such a manner that a concentration of the polyvinylidene fluoride would be 6% by mass, and the resultant solution was stirred in a dual arm-type mixer to prepare a positive electrode slurry. The positive electrode slurry was applied to both sides of a 20 μm-thick aluminum foil as a positive electrode current collector, and dried, and a resultant thereof was subject to pressing to obtain a positive electrode having a positive active material layer.

[Appearance of Battery Element]

In an atmosphere at a temperature of 25±3° C. and a relative humidity of 50±10%, a battery element was prepared in the same steps as described above, and the battery element was left to stand in the same atmosphere for 1 hour. A maximum diameter (mm) of the battery element was measured before and after the battery element was left to stand for 1 hour, and an expansion ratio (%) was calculated from the following equation. A higher expansion ratio means that the battery element expands to a greater degree, and the battery element has a poorer appearance.

Expansion ratio (%)=(maximum diameter after leaving−maximum diameter before leaving)÷maximum diameter before leaving×100

—Evaluation Criteria—

A: The expansion ratio is less than 5%.

B: The expansion ratio is 5% or more but less than 10%.

C: The expansion ratio is 10% or more.

[Pass Ratio of Battery Element]

In an atmosphere at a temperature of 25±3° C. and a relative humidity of 50±10%, 20 battery elements were prepared in the same steps as described above, and were each subjected to heat-pressing (pressure: 1 MPa, temperature: 95° C.). The battery elements after the heat-pressing were each disassembled, and electrodes and separators therefrom were observed. Battery elements having no cracks in electrodes and no creases and breaks in separators were determined as passed products, and a pass ratio for the 20 battery elements (the number of passed products±20×100) was calculated.

TABLE 1

| | | | | | | | | | Primary roll |
|---|---|---|---|---|---|---|---|---|---|
| | | | | | | | | | (after heat treatment) |
| | | | | | | | | | MD-direction |
| | | Coating liquid | | Temperature | Total | Thickness | | Appearance | shrinkage |
| | Porous | | Inorganic | of coagulation | draw | of composite | Heat | of primary | rate |
| | substrate | Resin | particle | liquid | rate | film | treatment | roll | at 25° C. |
| Example 1 | Polyethylene | PVDF | — | 35° C. | 102.0% | 12 μm | 75° C., 24 | A | 0.4% |
| | microporous | resin | | | | | hours | | |
| | film | | | | | | | | |
| Example 2 | Polyethylene | PVDF | — | 35° C. | 102.0% | 12 μm | 50° C., 24 | A | 0.8% |
| | microporous | resin | | | | | hours | | |
| | film | | | | | | | | |
| Example 3 | Polyethylene | PVDF | — | 35° C. | 103.0% | 12 μm | 50° C., 24 | B | 1.0% |
| | microporous | resin | | | | | hours | | |
| | film | | | | | | | | |
| Example 4 | Polyethylene | PMIA | α-alumina | 35° C. | 102.0% | 16 μm | 75° C., 24 | A | 0.4% |
| | microporous | | | | | | hours | | |
| | film | | | | | | | | |
| Example 5 | Polyethylene | PMIA | α-alumina | 35° C. | 103.0% | 16 μm | 75° C., 24 | B | 0.8% |
| | microporous | | | | | | hours | | |
| | film | | | | | | | | |
| Example 6 | Aramid fiber | PMIA | α-alumina | 35° C. | 100.2% | 40 μm | 75° C., 24 | B | 0.1% |
| | nonwoven | | | | | | hours | | |
| | fabric | | | | | | | | |
| Example 7 | PET fiber | PVDF | α-alumina | 35° C. | 100.2% | 40 μm | 75° C., 24 | B | 0.1% |
| | nonwoven | resin | | | | | hours | | |
| | fabric | | | | | | | | |
| Comparative | Polyethylene | PVDF | — | 35° C. | 102.0% | 12 μm | 35° C., 24 | A | 1.2% |
| Example 1 | microporous | resin | | | | | hours | | |
| | film | | | | | | | | |
| Comparative | Polyethylene | PVDF | — | 50° C. | 103.5% | 12 μm | — | C | 2.1% |
| Example 2 | microporous | resin | | | | | | | |
| | film | | | | | | | | |

| | Primary roll (after heat treatment) | | Secondary roll | | | | | |
|---|---|---|---|---|---|---|---|---|
| | | MD-direction | | | MD-direction | | | |
| | TD-direction | thermal | MD-direction | TD-direction | thermal | | | |
| | enlargement | shrinkage | shrinkage | enlargement | shrinkage | Battery element | | |
| | rate at | rate at | rate at | rate at | rate at | Winding | | Pass |
| | 25° C. | 135° C. | 25° C. | 25° C. | 135° C. | displacement | Appearance | ratio |
| Example 1 | 0.20% | 19% | 0.4% | 0.18% | 20% | Not | A | 100% |
| | | | | | | observed | | |
| Example 2 | 0.46% | 19% | 0.9% | 0.52% | 21% | Not | B | 80% |
| | | | | | | observed | | |
| Example 3 | 0.75% | 21% | 1.0% | 0.60% | 21% | Not | B | 60% |
| | | | | | | observed | | |
| Example 4 | 0.09% | 12% | 0.3% | 0.07% | 12% | Not | B | 90% |
| | | | | | | observed | | |
| Example 5 | 0.50% | 11% | 0.9% | 0.55% | 12% | Not | B | 60% |
| | | | | | | observed | | |
| Example 6 | 0.03% | 1% | 0.1% | 0.02% | 1% | Not | A | 80% |
| | | | | | | observed | | |
| Example 7 | 0.04% | 2% | 0.1% | 0.03% | 2% | Not | A | 90% |
| | | | | | | observed | | |
| Comparative | 0.60% | 23% | 1.1% | 0.55% | 22% | Not | C | 30% |
| Example 1 | | | | | | observed | | |
| Comparative | 1.35% | 24% | 2.0% | 1.21% | 23% | Observed | C | 0% |
| Example 2 | | | | | | | | |

The disclosure of Japanese Patent Application No. 2014-143662, filed on July 11, 2014, is incorporated herein by reference in their entirety.

All publications, patent applications, and technical standards mentioned in this specification are herein incorporated by reference to the same extent as if each individual publication, patent application, or technical standard was specifically and individually indicated to be incorporated by reference.

What is claimed is:

1. A separator roll comprising:
a non-aqueous electrolyte battery separator wound around a core, the non-aqueous electrolyte battery separator comprising:
a porous substrate; and
a porous layer obtained by solidifying a coating layer formed by coating one side or both sides of the porous substrate with a coating liquid, the coating liquid comprising at least one of a resin or an inorganic particle,
the non-aqueous electrolyte battery separator having a shrinkage rate in a machine direction, determined by a method (1), of 1.0% or less, the method (1) comprising:
removing, from the separator roll, the non-aqueous electrolyte battery separator by five revolutions of the separator roll starting from an outer end of the separator roll, and cutting out, from an end of the separator roll that remains after the removing, a piece of the non-aqueous electrolyte battery separator having a length of 200 mm in the machine direction, to prepare a sample;
leaving the sample in a tensionless state at 25° C. for 24 hours;
measuring a length of the sample in the machine direction before and after the leaving; and
calculating the shrinkage rate in the machine direction in accordance with the following equation:
shrinkage rate (%) in machine direction=(length in machine direction before leaving−length in machine direction after leaving)÷length in machine direction before leaving×100.

2. The separator roll according to claim 1, wherein the porous substrate comprises a thermoplastic resin having a melting temperature lower than 200° C.

3. The separator roll according to claim 1, wherein:
the separator roll is a primary roll obtained by winding the non-aqueous electrolyte battery separator directly around a core after production of the non-aqueous electrolyte battery separator, or a secondary roll obtained by winding, around a core, the non-aqueous electrolyte battery separator unwound from the primary roll, and
the primary roll is a separator roll obtained by winding the non-aqueous electrolyte battery separator around a core at a winding speed that is from 100% to 103% of a feeding speed of the porous substrate.

4. The separator roll according to claim 1, wherein:
the separator roll is a primary roll obtained by winding the non-aqueous electrolyte battery separator directly around a core after production of the non-aqueous electrolyte battery separator, or a secondary roll obtained by winding, around a core, the non-aqueous electrolyte battery separator unwound from the primary roll, and
the primary roll is a separator roll subjected to a treatment including leaving the primary roll to stand in an atmosphere from 40° C. to 110° C. for 12 hours or more.

5. The separator roll according to claim 1, wherein the non-aqueous electrolyte battery separator has an enlargement rate in a transverse direction, determined by a method (2), of from 0% to 0.6%, the method (2) comprising:
removing, from the separator roll, the non-aqueous electrolyte battery separator by five revolutions of the separator roll starting from an outer end of the separator roll, and cutting, from an end of the separator roll that remains after the removing, a piece of the non-aqueous electrolyte battery separator having a length of 200 mm in the machine direction, to prepare a sample;
leaving the sample in a tensionless state at 25° C. for 24 hours;
measuring a length of the sample in the transverse direction before and after the leaving; and
calculating the enlargement rate in the transverse direction in accordance with the following equation:
enlargement rate (%) in transverse direction=(length in transverse direction after leaving−length in transverse direction before leaving)÷length in transverse direction before leaving×100.

6. The separator roll according to claim 1, wherein the non-aqueous electrolyte battery separator has a thermal shrinkage rate in the machine direction, determined by a method (3), of from 3% to 40%, the method (3) comprising:
cutting out the non-aqueous electrolyte battery separator from the separator roll to obtain a sample having a length of 190 mm in the machine direction;
subjecting the sample to a heat treatment by leaving the sample in a tensionless state at 135° C. for 30 minutes;
measuring a length in the machine direction before and after the heat treatment; and
calculating the thermal shrinkage rate in the machine direction in accordance with the following equation:
thermal shrinkage rate (%) in machine direction=(length in machine direction before heat treatment−length in machine direction after heat treatment)÷length in machine direction before heat treatment×100.

7. The separator roll according to claim 1, wherein the shrinkage rate of the non-aqueous electrolyte battery separator in the machine direction, determined by the method (1), is 0.5% or less.

8. The separator roll according to claim 1, wherein the coating liquid comprises an adhesive resin.

9. A non-aqueous secondary battery comprising:
a positive electrode;
a negative electrode; and
a non-aqueous electrolyte battery separator that is supplied from the separator roll according to claim 1, and that is disposed between the positive electrode and the negative electrode,
the non-aqueous secondary battery producing an electromotive force by lithium doping/de-doping.
